(19) United States
(12) Patent Application Publication
(10) Pub. No.: US 2012/0278552 A1
(43) Pub. Date: Nov. 1, 2012

(54) REMOTE EXECUTION OF RAID IN LARGE TOPOLOGIES

(75) Inventors: Rajendra Singh, West Bengal (IN); Sourin Sarkar, Bangalore (IN)

(73) Assignee: LSI Corporation, Milpitas, CA (US)

(21) Appl. No.: 13/096,404

(22) Filed: Apr. 28, 2011

(51) Int. Cl. G06F 12/08

(52) U.S. Cl. 711/114; 711/E12.019

(57) ABSTRACT

A SAS expander for use in a SAS topology includes a receiving portion and a controller. The receiving portion is configured to receive a remote RAID instruction from a root host bus adapter. The controller is configured to execute the instruction to manage a RAID volume in accordance with a RAID management task specified by the instruction.

### TECHNICAL FIELD

This application is directed, in general, to information storage and retrieval, and more particularly, to systems for operating a redundant array of independent disks (RAID) and methods of forming and operating such systems.

### BACKGROUND

Information storage systems that use redundant array of independent disks (RAID) technology provide augmented storage of digital information. Such systems may use an array of hard disk drives (HDDs) or similar devices such as solid state disks (SSDs) to store information in various ways. For example, information throughput may be increased over that of a single HDD by organizing multiple HDDs in a RAID 0, or striped, array. In another example, redundant storage of critical information may be provided by organizing the HDDs in a RAID 1 array.

A RAID system may include a topology, e.g. a root host bus adapter (HBA) at the top of a tree of SAS expanders, with storage media connected to some of the expanders. The storage media are arranged as RAID volumes. The RAID volumes typically rely on a controller to perform various tasks related to establishing and maintaining the chosen volume type, such as a redundant array. For instance, the HBA may periodically initiate a task to determine that one of a redundant pair of disks is an exact duplicate of the other of the pair. If the HBA detects differences, the HBA may initiate a task to correct such differences. If one of the pair is replaced, the HBA may initiate a task to duplicate the information contained on the older disk to the replacement disk. In a large array the performance of the SAS topology may degrade when the HBA is unable to meet the demands for various tasks in a timely manner.

### SUMMARY

One embodiment provides a SAS expander for use in a SAS topology. The SAS expander includes a receiving portion and a controller. The receiving portion is configured to receive a remote RAID instruction from a root host bus adapter. The controller is configured to execute the instruction to manage a RAID volume in accordance with a RAID management task specified by the instruction.

Another embodiment provides a SAS topology that includes a root host bus adapter and a SAS expander. The root host bus adapter is configured to transmit a remote RAID instruction over a SAS link. The SAS expander includes a receiving portion and a controller. The receiving portion is configured to receive the remote RAID instruction from the root host bus adapter. The controller is configured to execute the remote RAID instruction to manage a RAID volume in accordance with a RAID management task specified by the instruction.

Yet another embodiment provides a method of manufacturing a RAID system. The method includes configuring a root host bus adapter to transmit a remote RAID instruction over a SAS link. The method further includes configuring a SAS expander to receive the remote RAID instruction from the root host bus adapter, and to execute the instruction to manage a RAID volume in accordance with a RAID management task specified by the instruction.

### BRIEF DESCRIPTION

Reference is now made to the following descriptions taken in conjunction with the accompanying drawings, in which:

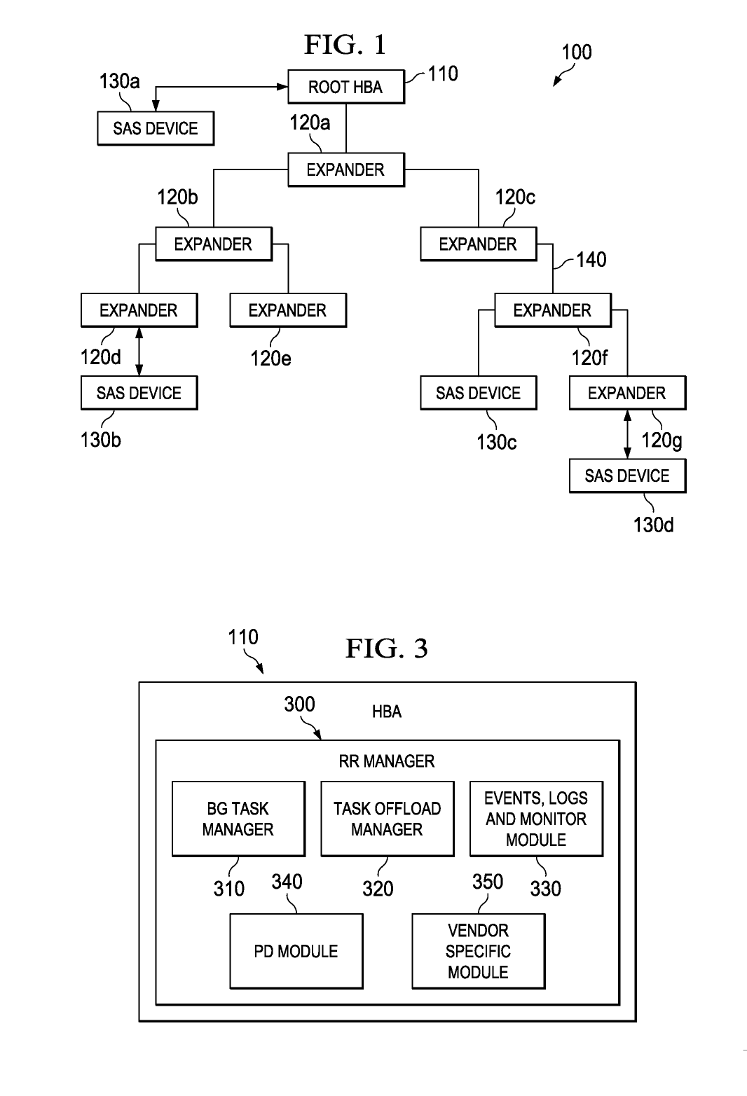

FIG. 1 illustrates a SAS topology in one embodiment of the disclosure, including a host bus adapter, expanders and storage media;

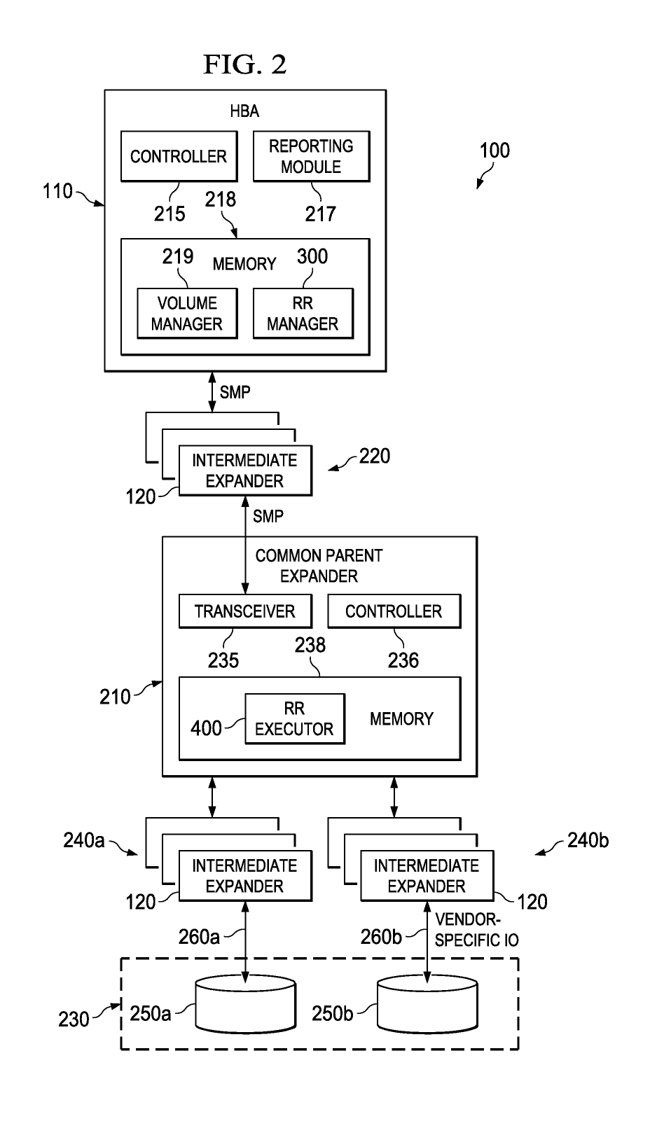

FIG. 2 illustrates the SAS topology of FIG. 1 in one embodiment of the disclosure, including details of the host bus adapter, and a first level common parent expander;

FIG. 3 illustrates aspects of the HBA of FIG. 2, including a remote RAID manager, in one embodiment of the disclosure;

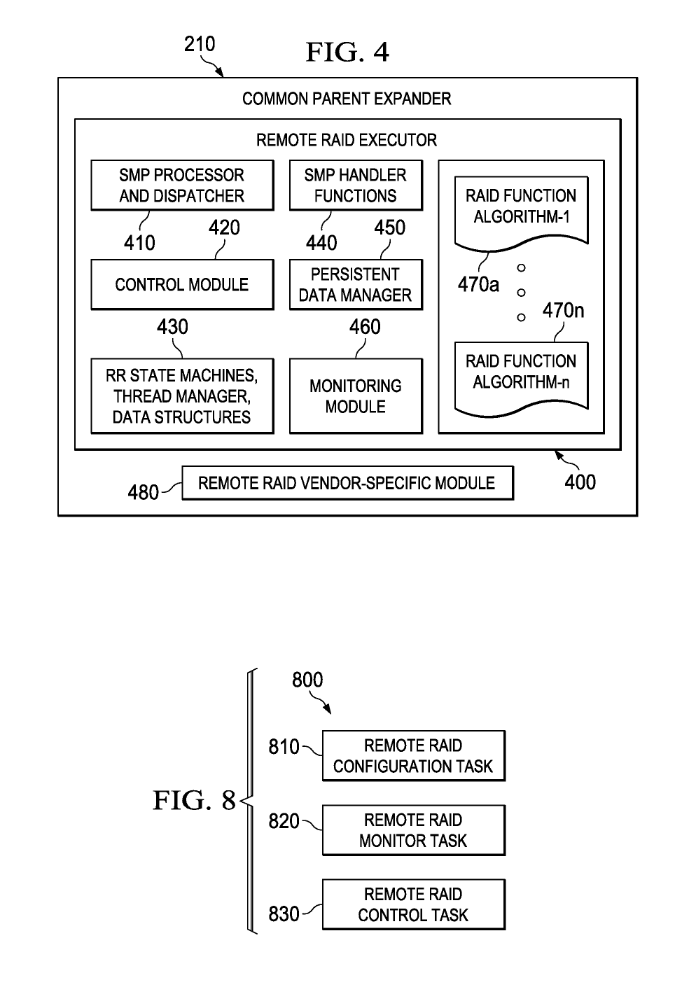

FIG. 4. illustrates aspects of the first level common parent expander of FIG. 2, including a remote RAID executor, in one embodiment of the disclosure;

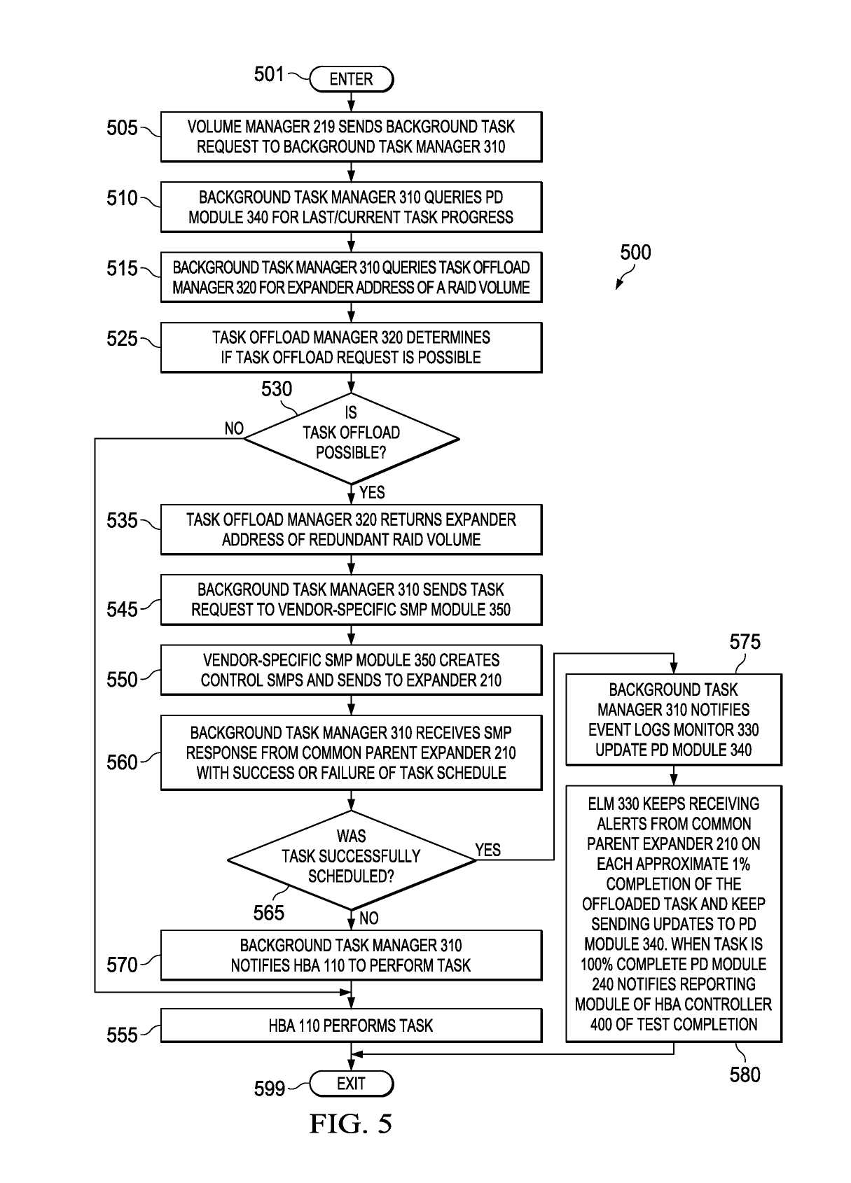

FIG. 5 illustrates a method of operating the host bus adapter of FIGS. 2 and 3, in one embodiment of the disclosure;

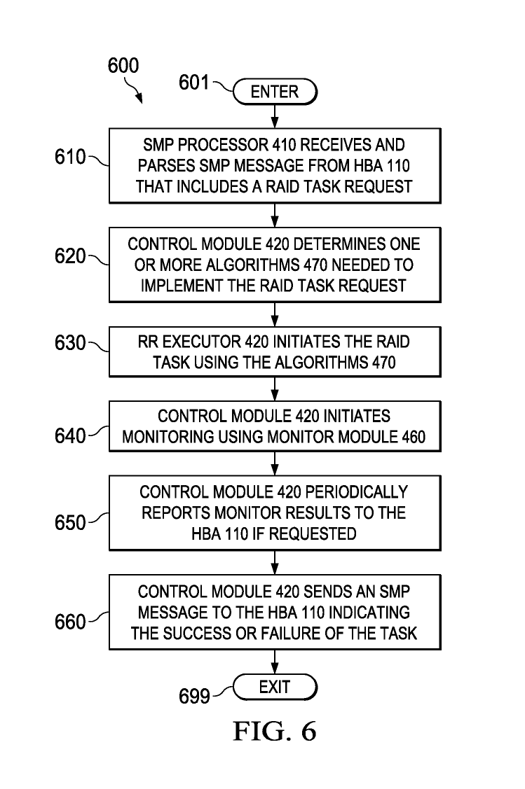

FIG. 6 illustrates a method of operating the expander of FIGS. 2 and 4, in one embodiment of the disclosure;

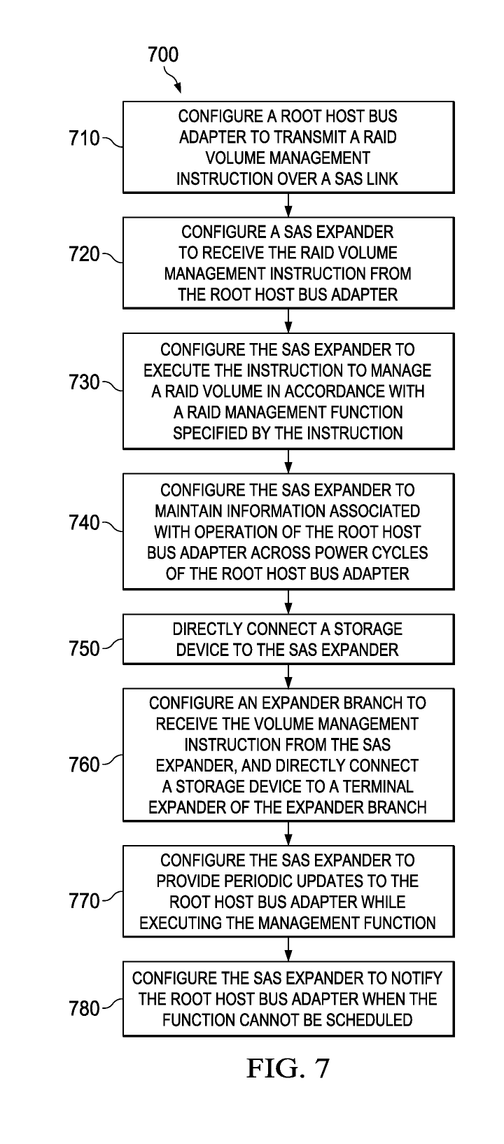

FIG. 7 illustrates a method of manufacturing a SAS topology, e.g. the topology of FIG. 1, in one embodiment of the disclosure; and

FIG. 8 illustrates remote RAID SMP messages that may be issued by the HBA of FIG. 2 according to one embodiment of the disclosure.

### DETAILED DESCRIPTION

A large serial attached SCSI (SAS) topology may include a large number of SAS expanders and interconnections (e.g. SAS links) between the expanders. Some RAID tasks conventionally administered by the host bus adapter (HBA) impose a significant load on the computational resources available to the HBA. In some cases the burden of administering the topology may increase the latency of various RAID tasks when demand on the HBA resources is high. Thus the performance of the entire SAS topology may be significantly reduced when the HBA is administering a resource-intensive task.

For example, a typical conventional RAID Consistency Check (CC) task may include the following sub-tasks administered by the HBA:
1) The HBA reads in data from a primary hard disk drive (HDD) of a redundant pair of disk drives connected to a SAS expander and stores the data in a first data buffer.
2) The HBA reads in data from a secondary HDD of the redundant pair and stores the data in a second data buffer.
3) The HBA compares the data in the first and second data buffers to determine if the data are consistent.

In this example of conventional operation SAS protocol packets traverse the full length of the topology chain from the HBA to the SAS expander(s) to which the HDDs are attached to retrieve the data from the HDDs. SAS protocol packets then traverse the full length of the topology chain back to the HBA, at which point the data sets are compared. Other RAID management tasks such as Resynchronization (RESYNC), Background Initialization (BGI), Make Data Consistent (MDC) and Data Scrub (DS) may impose similar burdens on the SAS topology and the root HBA.

Embodiments described herein and within the scope of the disclosure advantageously reduce the loading on the HBA by, e.g. shifting some of the burden of administering RAID volumes from the HBA to one or more of the expanders within the SAS topology. In particular, in various embodiments a first level common parent expander, described below, may include a number of small routines, e.g. in firmware, to carry out the various operations involved in administering one or more RAID management tasks that would otherwise burden the HBA. Hereinafter the term “common parent expander”, if not otherwise modified, is understood to mean a first level common parent expander.

In various embodiments described herein the HBA directs the SAS expander to perform a particular RAID management task by transmitting to the expander one or more SMP messages over a SAS link of the SAS topology. Herein and in the claims a SAS link is a data path between two devices configured to communicate using the SAS communication protocol as defined by applicable current and future standards. The common parent expander may execute the task without significant further involvement by the HBA. The common parent expander may alert the HBA upon the completion of the task, after which the HBA may take further action as appropriate. The common parent expander may thereby relieve the HBA of the burden of various tasks related to the implementation and management of the RAID volume controlled by the expander. In many cases it is expected that the HBA may operate more efficiently to control operation of the SAS topology of which the HBA and the common parent expander are a part.

FIG. 1 presents an illustrative SAS topology 100 according to one embodiment of the disclosure. The topology includes a root HBA 110, SAS expanders 120a-g referred to collectively as SAS expanders 120, and SAS devices 130a-d referred to collectively as SAS devices 130. The components of the SAS topology communicate via SAS links 140. Each expander 120 may be normal or self configuring. A normal expander 120 does not implement discovery of SAS topology on its own. It requires the root HBA 110 to perform discovery of the SAS topology 100, from which the root HBA 110 may program routing tables stored by the normal expander 120. A self configuring expander 120 is capable of performing discovery of the SAS topology from which the self configuring expander 120 programs its own routing table.

The SAS devices 130 are representative of storage devices on which a RAID volume may be created. Management of the RAID volume on two or more particular instances of the SAS device 130 may be managed by the root HBA 110 or the lowest expander 120 that is at the top of a topology branch that includes those SAS devices 130. This lowest expander 120 is referred to a first level common parent expander. Thus, the following examples illustrate management of various RAID implementations:
The expander 120g may manage a RAID volume created on the SAS device 130d. Similarly the expander 120d may manage a RAID volume created on the SAS device 130b.
The expander 120f may manage a RAID volume that includes either or both of the SAS devices 130c and 130d. The expander 120f is the lowest expander that may manage a RAID volume that includes both of the SAS devices 130c and 130d. Thus the expander 120f is the first level common parent expander to the SAS devices 130c and 130d. An expander 120 located between a first level common parent expander and the SAS devices is referred to herein as an intermediate expander. Herein an expander 120 below the first level common parent expander to which the SAS device 130 is connected may be referred to as a terminal expander. Thus, for example, the expander 120g is a terminal expander of the expander branch below the expander 120a.
The expander 120a may manage a RAID volume that includes any or all of the SAS devices 130b, 130c and 130d. The expander 120a is the first level common parent with respect to these SAS devices. The expander 120 sits at the top of two branches. Herein an expander branch is a series of expanders 120 in the RAID topology that are between the first level common parent expander and the SAS device 130.
The root HBA 110 may manage a RAID volume that includes any or all of the SAS devices 130a-d. Because the SAS device 130a is directly connected to the root HBA 110, the root HBA 110 typically must manage a RAID volume that includes the SAS device 130a.

FIG. 2 illustrates the SAS topology 100 with a first level common parent expander 210 connected to the root HBA 110 via a number of intermediate expanders 120 represented as an expander branch 220. The expander branch 220 includes all the expanders 120 directly between the root HBA 110 and the common parent expander 210. The common parent expander 210 is connected to a first storage device 250a via a number of expanders 120 in an expander branch 240a. The common parent expander 210 is connected to a second storage device 250b via a number of expanders 120 in an expander branch 240b. The storage devices 250a,b are operated as a single RAID volume 230. Data paths 260a,b between the expander branches 240a,b and the storage devices 250a,b may include vendor-specific IO, as described below. In some embodiments the storage devices 250a,b are connected to a same expander 120, which is then considered as the common parent expander 210.

The root HBA 110 is configured to communicate with the common parent expander 210 via connections between the expanders 120, e.g. SAS links 140. The communication may be by any protocol associated with SAS topologies, such as serial management protocol (SMP).

The storage devices 250a, 250b operate within the constraints of a predefined relationship of the RAID volume 230. The relationship may be, e.g. that of a primary and a secondary disk drive of a redundant array of disk drives. Each storage device 250a,b may be, e.g. a physical disk drive such as a hard disk drive or a solid-state drive. The RAID volume 230 may operate, e.g. as a redundant-type RAID array. Examples of redundant-type type RAID arrays include RAID 1 comprising two physical drives, and RAID 10 comprising n physical drives, where n is an even number greater than two.

In one aspect the root HBA 110 includes a controller 215 and a memory 218. The controller 215 may be any suitable general purpose or customized processor, microcontroller, or finite state machine (FSM), designed and/or adapted to operate according to program instructions stored by the memory 218. Nonlimiting examples of suitable processors include an ARM or PowerPC™ processor. The memory 218 may be any type of storage medium suitable for storage of program instructions executable by the controller 215, e.g. firmware. In some embodiments a persistent memory such as a read-only memory (ROM) may be preferred.

In one aspect the root HBA 110 is adapted to execute instructions of a program designed to implement various conventional functions related to operation of the SAS topology 100, and more particularly the RAID volume 230. For example, the memory 218 includes program instructions that configure the root HBA 110 to communicate with the common parent expander 210 and intermediate expanders 120. Among the program instructions are those that implement a volume manager 219. The volume manager 219 includes processes for managing the overall operation of RAID volumes, e.g. disk arrays, within the SAS topology 100. For example, the volume manager 219 may be configured to detect the need to start, stop, resume, pause and/or abort a background task on the RAID volume 230. Those skilled in the pertinent art are familiar with these and other volume management functions.

In another aspect the root HBA 110 is adapted to implement novel functions associated with instructing the common parent expander 210 to directly perform various RAID volume management tasks with respect to the RAID volume 230. More specifically, as described further below, the HBA 110 is configured to transmit a remote RAID instruction to a SAS expander 120 acting as the common parent expander 210. Herein a remote RAID instruction is a communication from the HBA 110 that includes a RAID management task to be performed by the common parent expander 210. RAID management tasks are described below. The remote RAID instruction specifies a RAID management task that is implemented by the common parent expander 210, thereby reducing the load on the HBA 110.

The common parent expander 210 includes a transceiver 235, controller 236, and a memory 238. The transceiver 235 operates to receive configuration commands from the root HBA 110 via SMP commands, and to make the commands available to the controller 236. The controller 236 may again be a suitable general purpose or customized processor, microcontroller, or FSM, designed and/or adapted to operate according to instructions stored by the memory 238. Nonlimiting examples of suitable processors include an ARM or PowerPC™ processor. The memory 238 may be any type of storage medium suitable for storage of program instructions executable by the controller 236. In some embodiments a persistent memory such as a ROM may be preferred. The memory 238 includes operating instructions, e.g. firmware, that configure the common parent expander 210 to communicate with the root HBA 110, the RAID volume 230 and any intermediate expanders 120.

The root HBA 110 and the common parent expander 210 are configured to cooperate to implement RAID management functions on the common parent expander 210. In particular, as described further below the root HBA 110 includes program instructions that implement a remote RAID (RR) manager 300, and the common parent expander 210 includes instructions that implement a remote RAID executor 400. As used herein the terms “remote RAID” and RR refer to a RAID architecture in which one or more SAS expanders 120 such as the common parent expander 210 operates to implement RAID management tasks or functions that are reserved to an HBA in conventional RAID topologies.

In various embodiments the root HBA 110 delegates RAID activities to the common parent expander 210. In various embodiments the common parent expander 210 is configured to execute only a subset of functions provided by applicable SAS standards so that complexity of the common parent expander 210 is reduced from that required for full SAS compatibility.

The remote RAID manager 300 is generally responsible for executing one or more functions that implement remote RAID operation. The remote RAID executor 400 is generally responsible for receiving commands from the root HBA 110 via the expander branch 220 and the transceiver 235 that direct it to perform a RAID operation, and executing the received commands. For example, and as described further below, the remote RAID manager 300 may direct the remote RAID executor 400 to communicate with the RAID volume 230 to perform a RAID management task such as previously described. The common parent expander 210 may manage the operation of the RAID volume 230 with little or no further involvement by the root HBA 110 after the root HBA 110 issues one or more remote RAID instructions to the common parent expander 210.

In various embodiments the remote RAID manager 300 acts as a master and the remote RAID executor 400 operates as a slave under the control of the remote RAID manager 300. Thus, for example, the remote RAID tasks are only initiated by the remote RAID manager 300, and once received by the remote RAID executor 400, execution of such tasks is nondiscretionary. However, the remote RAID executor 400 retains the ability to initiate communications with the remote RAID manager 300, e.g. to report task progress or any failures of the requested RAID task.

FIG. 3 illustrates the remote RAID manager 300 in greater detail. Included are a background task manager 310, a task offload manager 320, an events, logs and monitor (ELM) module 330, a persistent data (PD) module 340 and a vendor-specific module 350. These modules may be implemented in various embodiments as interrupt-driven subroutines or objects within the firmware stored in the memory 218. Embodiments of the disclosure are not limited to any particular programming language or structure. Specific implementations of the various modules described herein may be determined without undue experimentation by those skilled in the pertinent art.

The background task manager 310 operates to provide background processing to support delegating RAID management tasks to the common parent expander 210. Thus, for example, the background task manager 310 may be periodically invoked to issue instructions to the common parent expander 210, perform bookkeeping or check various status flags.

The task offload manager 320 includes instructions that implement the transfer of an SMP command to the common parent expander 210. In various embodiments the task offload manager 320 is configured to determine the first level parent expander 210 of redundant drives, e.g. the storage devices 250. The task offload manager 320 may respond to a request from the background task manager 310. For example, the background task manager 310 may query the task offload manager 320 for information on the storage devices 250. The information may include, e.g. an SAS address or a device handle of the common parent expander 210 to which the storage devices 250 are attached, or the status of a RAID task operating with respect to the storage devices 250. The task offload manager 320 may further be configured to determine if it is possible to offload, e.g. schedule, a RAID management task associated with a particular RAID volume. For example, it may not be possible to schedule a RAID task involving the storage devices 250 when the task offload manager 320 is unable to identify a parent expander 120 that is common to the storage devices 250a, 250b.

The ELM module 330 logs events and monitors various signals and flags returned by the remote RAID executor 400. For example, in various embodiments the common parent expander 210 is configured to send periodic status events to the root HBA 110, such as when the common parent expander 210 has initiated a RAID task involving the storage devices 250, and to monitor progress of the task. The common parent expander 210 may send an update, e.g. after each 1% of the scheduled task is complete. The ELM module 330 may record a history of such events and notify the PD module 340 of changes to the history. In various embodiments the background task manager 310 consults the PD module 340 to get information about any task that was previously running and its last saved status. For example, the background task manager 310 may use such information to recover from a power cycle event.

The PD module 340 records the progress of some or all of the background tasks running on the RAID volume 230 and any other volumes on the topology 100 in a persistent, e.g. nonvolatile, memory. In various embodiments the PD module 340 processes events received from one or more instances of the common parent expander 210 and stores a record of the event into the persistent memory. The PD module 340 may also communicate progress to a reporting module 217 (FIG. 2) within the root HBA 110 RAID firmware for each unit of the RAID tasks completed. For instance, the reporting module 217 may use these data in some embodiments to notify host management application(s) and/or SNMP agents of the task running status.

The vendor-specific module 350 includes hardware-dependent instructions tailored to the specific requirements of the remote RAID manager 300. In various embodiments the vendor-specific module 350 understands non-standard, e.g. custom/vendor-specific protocol messages that support specific embodiments of the storage devices 250. The vendor-specific module 350 may complement a remote RAID vendor specific-module 480 in the common parent expander 210, described below.

FIG. 4 illustrates the remote RAID executor 400 in greater detail. Included are an SMP processor and dispatcher module 410; a control module 420; a state machines, thread manager and data structures module 430; an SMP handler function module 440; a persistent data manager 450; a monitoring module 460; and RAID function algorithms 470a . . . 470n. Embodiments of the disclosure are not limited to any particular programming language or structure. Specific implementations of the various modules described herein may be determined without undue experimentation by those skilled in the pertinent art.

The SMP processor and dispatcher module 410 is configured to recognize a remote RAID SMP message when such a message is received by the common parent expander 210. The module 410 may be configured to, upon receiving such a message, parse the message and provide relevant parameters to other modules within the remote RAID executor 400. In some cases the module 410 passes parameters to the control module 420. The control module 420 may then operate the common parent expander 210 to execute the RAID management tasks associated with the RAID volume 230 consistent with the remote RAID SMP message.

The handler function module 440 determines the actions that need to be taken and fetches the relevant task algorithm from the appropriate algorithm 470n. Any required state machines, thread management, and data structures are used from the module 430. While a task is in progress the remote RAID manager 300 may need to start, stop, cancel, or resume (e.g. after a power cycle) a task. Such control is provided by the control module 420. The persistent data manager 450 provides similar function as described for the PD module 340, e.g. to maintain data across power cycles for a task that is in progress. The manager 450 may operate in cooperation with a nonvolatile memory to save and retrieve persistent data. The monitoring module 460 is configured to maintain statistical or status data during the execution of a RAID task. For example, the module 460 may maintain a historical database of the completion status of previously scheduled RAID task requests. A nonvolatile memory such as a flash memory may be used when the database is to be stored across power cycles.

The common parent expander 210 may also include the remote RAID vendor-specific module 480 mentioned previously. The module 480 provides specific hardware-dependent instructions and/or parameters needed to properly communicate with the specific storage devices 250 used in the RAID volume 230.

In some embodiments the HBA 110 is configured to issue remote RAID instructions by way of remote RAID SMP messages that control remote RAID operations. FIG. 8 illustrates three illustrative remote RAID SMP messages, including a Remote RAID Configure Task message 810, a Remote RAID Monitor Task message 820 and a Remote RAID Control Task message 830.

The Remote RAID Configure Task SMP message 810 may be used to configure the remote RAID operation. As such the message 810 may include various instructions directing the operation of the common parent expander 210. Recalling that the common parent expander 210 operates in a slave mode in various embodiments, the remote RAID executor 400 may be configured to execute the received remote RAID instructions without further confirmation or exchange of instructions or data with the root HBA 110. In some cases messages exchanged between the root HBA 110 and the common parent expander 210 may operate to support the status updates previously described. A nonlimiting list of example contents of the Remote RAID Configure Task SMP message 810 includes: target specification for the operation; type of operation, e.g. a RAID management function such as RESYNC, BGI, MDC, CC or DS; type of algorithm needed to execute the operation; type of monitoring information that the common parent expander 210 collects and reports to the root HBA 110; a directive to maintain information in nonvolatile memory for retrieval after power interruption to the root HBA 110 and/or the common parent expander 210; and a flag that indicates whether the operation may be cancelled. It is noted that the operation types may include RAID functions defined in future revisions to the RAID standards.

The Remote RAID Monitor Task SMP message 820 instructs the common parent expander 210 to monitor a task that has been previously assigned and may still be executing. The remote RAID manager 300 may include in this message the identification of the task for which monitoring information is requested. The Remote RAID Executor 400 may be configured to respond to the Remote RAID Monitor Task SMP message 820 with some or all available monitoring data depending on a function code provided in the request message. The function code may specify, e.g. a default monitor data set that provides only summary information or an extended monitor data set that provides additional information.

The Remote RAID Control Task SMP message 830 may act to control aspects of the operation of a task that has already been configured, and may still be executing within the common parent expander 210. A sub-function code may be used to specify the control action. A nonlimiting list of example sub-function codes includes: start a previously configured task; stop a task currently executing; cancel a task that that has been scheduled, and may or may not be executing; and resume a task that was previously stopped but not cancelled.

FIG. 5 illustrates a method 500 that illustrates operation of the SAS topology 100 in one specific embodiment. Those skilled in the pertinent art will appreciate that other operation flows are possible and within the scope of the disclosure. For example, the steps of the method 500 may be performed in another order than the illustrated order.

In the method 500 the root HBA 110 is initially operating under the control of RAID management firmware. The RAID management firmware operates to create and/or manage a number of RAID volumes, including the RAID volume 230. The RAID management firmware transfers control to the method 500 at an entry step 501.

In a step 505, the volume manager 219 sends a background task request to the background task manager 310 to perform an action with respect to a background task associated with the RAID volume 230. The action may be, e.g. one of starting, stopping, resuming, pausing or aborting the task. Nonlimiting examples of background tasks include, e.g. RESYNC, BGI, MDC, CC or DS. The request may include a volume identifier V identifying the RAID volume 230, a task type T, a list D₁, D₂ . . . Dₙ of one or more of the storage devices 250 (e.g. HDDs) within the RAID volume 230, or a directive ALL to include all physical devices of the RAID volume 230. In some embodiments the volume manager 219 may also send one or more parameters to the background task manager 310 that are specific to a particular embodiment, such as for some types of HDDs.

In a step 510 the background task manager 310 queries the PD module 340 for the current task progress, or if no task is running the last recorded task progress.

In a step 515 the background task manager 310 queries the task offload manager 320 for the address of the common parent expander 210 associated with a RAID volume, e.g. the RAID volume 230.

In a step 525 the offload manager 320 determines if it is possible to schedule the task. It may not be possible, e.g. when the task offload manager 320 cannot find a common parent expander 120. For example, one of the storage devices 250 may be connected directly to the root HBA 110, such as the SAS device 130a in FIG. 1.

In a decisional step 530, the method 500 branches to a step 555 if the common parent expander 210 is unable to perform the requested task. In the step 555 the root HBA 110 performs the task and returns 599 from the method 500.

If the task offload manager 320 can find a common parent expander 210 then the method 500 proceeds to a step 535. In the step 535 the task offload manager 320 returns the expander address of the volume 230.

In a step 545 the task offload manager 320 sends the task request to the vendor-specific module 350. The request may include any of the requested background task T, a source physical drive SAS address D1, a destination physical drive SAS address D2, a start point P1 on D1, a start point P2 on D2, an end point E1 on D1, an end point E2 on D2, an algorithm type A, and any optional control flags.

In a step 550 the vendor-specific module 350 creates control SMP messages tailored to the particular storage device 250 that include the information transferred in the step 545 and sends the SMP messages to the common parent expander 210.

In a step 560 the task offload manager 320 receives an SMP response from the common parent expander 210 indicating the success or failure of scheduling the requested task. Success means that the common parent expander 210 has taken up the task properly and is capable of running the task, but does not necessarily indicate that the task has started or completed. The root HBA 110 is configured in some embodiments to expect a periodic update from the common parent expander 210 via an SMP message, indicating progress of the task.

In a decisional step 565, in the event that the task scheduling failed the method 500 branches to a step 570 in which the background task manager 310 requests the root HBA 110 to perform the task. The method 500 then continues with the step 555 previously described.

In the event that the requested task was successfully scheduled the step 565 advances to a step 575. In the step 575 the background task manager 310 notifies the ELM module 330 and updates the PD module 340.

In a step 580 the PD module 340 notifies the reporting module 217 of the success of each task completed by the common parent expander 210. The method 500 then returns 599.

FIG. 6 presents a method 600 that illustrates operation of the common parent expander 210 in one specific embodiment. Those skilled in the pertinent art will appreciate that other operation flows are possible and within the scope of the disclosure. For example, the steps of the method 600 may be performed in another order than the illustrated order.

The common parent expander 210 enters the method 600 with a step 601. At a step 610 the SMP processor and dispatcher module 410 receives and parses an SMP message from the root HBA 110. The module 410 determines that the SMP message conveys a RAID task request directed to the storage devices 250. The module 410 notifies the remote RAID executor 400 of the receipt of the task request.

In a step 620 the control module 420 receives the notification and determines one or more of the algorithms 470 needed to implement the RAID task request.

In a step 630 the control module 420 initiates the RAID task request using the selected algorithm(s) 470n.

In a step 640, the control module 420 initiates monitoring by the monitoring module 460.

In a step 650 the control module 420 periodically reports monitor results to the root HBA 110 if the root HBA 110 has requested such reports.

In a step 660 the control module 420 determines if the requested task successfully completed, and sends an SMP message to the root HBA 110 indicating the success or failure of the task.

The method 600 returns to the calling routine in a step 699.

FIG. 7 illustrates a method 700 of manufacturing a RAID system. The method 700 is presented referring without limitation to various components described herein, e.g. FIGS. 1-4. Moreover, the steps of the method 700 may be performed in an order different than the illustrated order. Those skilled in the pertinent art will appreciate that the scope of the disclosure includes methods that perform steps that may differ in form but operate equivalently.

In a step 710 a root host bus adapter, e.g. the root HBA 110, is configured to transmit a remote RAID instruction over a SAS link. In a step 720, a SAS expander, e.g. the first level common parent expander 210, is configured to receive the remote RAID instruction from the root host bus adapter. In a step 730, the SAS expander is configured to execute the remote RAID instruction to manage a RAID volume, e.g. the RAID volume 230, in accordance with a RAID management task specified by the instruction.

In a step 740, the SAS expander is configured to maintain information associated with operation of the root host bus adapter across power cycles of the root host bus adapter. In a step 750, a storage device of the RAID volume, e.g. the storage device 250, is directly connected to the SAS expander.

In a step 760, an expander branch, e.g. the expander branch 240a, is configured to receive the remote RAID instruction from the SAS expander. A storage device is directly connected to a terminal expander of the expander branch.

In a step 770 the SAS expander is configured to provide periodic updates to the root host bus adapter while executing the RAID management task. In a step 780 the SAS expander is configured to notify the root host bus adapter when the RAID management task cannot be scheduled.

Those skilled in the art to which this application relates will appreciate that other and further additions, deletions, substitutions and modifications may be made to the described embodiments.

What is claimed is:

1. A SAS expander for use in a SAS topology, comprising:
a receiving portion configured to receive a remote RAID instruction from a root host bus adapter; and
a controller configured to execute said instruction to manage a RAID volume in accordance with a RAID management task specified by said instruction.

2. The expander as recited in claim 1, further comprising a persistent data module configured to maintain information associated with scheduling said RAID management task across power cycles of said root host bus adapter.

3. The expander as recited in claim 1, wherein said RAID volume consists of one or more storage devices connected directly to said SAS expander.

4. The expander as recited in claim 1, wherein said controller is further configured to provide periodic updates to said root host bus adapter while executing said RAID management task.

5. The expander as recited in claim 1, wherein said controller is configured to notify said root host bus adapter when said RAID management task cannot be scheduled.

6. The expander as recited in claim 1, further comprising an expander branch configured to receive said volume management instruction from said SAS expander, and a storage device directly connected to a terminal expander of said expander branch.

7. The expander as recited in claim 1, wherein said RAID management task is selected from the group consisting of:
resynchronization;
background initialization;
make data consistent;
consistency check; and
data scrub.

8. A SAS topology, comprising:
a root host bus adapter configured to transmit a remote RAID instruction over a SAS link;
a SAS expander that includes:
a receiving portion configured to receive said remote RAID instruction from said root host bus adapter; and
a controller configured to execute said remote RAID instruction to manage a RAID volume in accordance with a RAID management task specified by said instruction.

9. The SAS topology as recited in claim 8, wherein said SAS expander further comprises a persistent data module configured to maintain information associated with operation of said root host bus adapter across power cycles of said root host bus adapter.

10. The SAS topology as recited in claim 8, further comprising a storage device directly connected to said SAS expander.

11. The SAS topology as recited in claim 8, further comprising an expander branch configured to receive said remote RAID instruction from said SAS expander, and a storage device directly connected to a terminal expander of said expander branch.

12. The SAS topology as recited in claim 8, wherein said controller is further configured to provide periodic updates to said root host bus adapter while executing said RAID management task.

13. The SAS topology as recited in claim 8, wherein said controller is configured to notify said root host bus adapter when said RAID management task cannot be scheduled.

14. The SAS topology as recited in claim 8, wherein said RAID management task is selected from the group consisting of:
resynchronization;
background initialization;
make data consistent;
consistency check; and
data scrub.

15. A method of manufacturing a RAID system, comprising:
configuring a root host bus adapter to transmit a remote RAID instruction over a SAS link; and
configuring a SAS expander to:
receive said remote RAID instruction from said root host bus adapter; and
execute said instruction to manage a RAID volume in accordance with a RAID management task specified by said instruction.

16. The method as recited in claim 15, further comprising configuring said SAS expander to maintain information associated with operation of said root host bus adapter across power cycles of said root host bus adapter.

17. The method as recited in claim 15, further comprising directly connecting a storage device to said SAS expander.

18. The method as recited in claim 15, further comprising configuring an expander branch to receive said remote RAID instruction from said SAS expander, and directly connecting a storage device to a terminal expander of said expander branch.

19. The method as recited in claim 15, further comprising configuring said SAS expander to provide periodic updates to said root host bus adapter while executing said RAID management task.

20. The method as recited in claim 15, further comprising configuring said SAS expander to notify said root host bus adapter when said RAID management task cannot be scheduled.
